(19) United States
(12) Patent Application Publication
(10) Pub. No.: US 2004/0137811 A1
(43) Pub. Date: Jul. 15, 2004

(54) Elastomeric seating composite

(75) Inventor: Roger Tornero, Greensboro, NC (US)

Correspondence Address: SHOOK, HARDY & BACON LLP, 2555 GRAND BLVD, KANSAS CITY,, MO, 64108, US

(73) Assignee: L & P Property Management Company

(21) Appl. No.: 10/339,003

(22) Filed: Jan. 9, 2003

(51) Int. Cl. B32B 27/12; B32B 27/04; B32B 5/24; B32B 5/18

(52) U.S. Cl. 442/38; 442/30

(57) ABSTRACT

A high resiliency elastomeric seating composite adapted for use on a chair is provided. The seating composite includes an adhesive layer positioned between a film layer and an elastomeric net material. The film layer may be formed of urethane, vinyl or a combination thereof and is cast onto a sheet of release paper. The release paper is removed from the film layer and the adhesive layer is positioned between the film layer and elastomeric net material. The film layer, adhesive layer and net material are then flame laminated to form the seating composite. The adhesive layer is formed of a urethane foam material and the elastomeric net material may be formed of a polyester elastomeric material that is woven or biaxially-oriented extruded. In an alternative embodiment, the film layer is cast directly on the net material without the use of the adhesive layer.

### CROSS REFERENCE TO RELATED APPLICATIONS

Not applicable.

### STATEMENT REGARDING FEDERALLY-SPONSORED RESEARCH OR DEVELOPMENT

Not applicable.

### BACKGROUND OF THE INVENTION

The present invention relates to an elastomeric seating composite. More specifically, this invention relates to a multi-layer elastomeric seating composite having high resiliency and adequate memory characteristics.

Various types of fabrics are currently being used to cover seat and back portions of a chair. For instance, it is well known to use a urethane vinyl blend material that is cast onto a non-woven substrate to cover a seat frame. This covering material may be formed in a number of different colors and grains to change the appearance and texture of the chair. In using these non-woven materials to cover a chair, it is typically necessary to mount springs, foam and other types of mechanisms underneath the non-woven substrate to provide the proper support for a user sitting in the chair. However, the installation of these chair support components along with the non-woven substrate material is a time-consuming and labor-intensive process which increases manufacturing costs. Moreover, the addition of these components necessarily affects the aesthetics of the chair.

In an effort to reduce the aforementioned manufacturing costs and aesthetic considerations, other types of seating materials have been developed that eliminate the need for using springs, foam and other types of support components in chairs. One alternative seating material is a mesh-type fabric that is stretched across the seat and back frame of the chair. The tension in the mesh fabric is adequate to provide the necessary support for a person sitting in the chair. However, the use of the mesh-type material also suffers from a number of disadvantages. For example, the use of a mesh-type material gives the exterior of a chair a relatively unfinished look, which reduces the aesthetic appearance of the chair. In addition, the texture of the mesh-type material is also undesirably abrasive.

Accordingly, there exists a need for a seating composite that has good resiliency and memory characteristics while providing for an aesthetically pleasing, non-abrasive covering for a chair. The present invention fills these needs as well as various other needs.

### BRIEF SUMMARY OF THE INVENTION

In order to overcome the above-stated problems and limitations, and to achieve the noted objects, there is provided a high resiliency elastomeric seating composite used to support a user sitting in a chair.

In general, the seating composite includes a film layer, an adhesive layer and an elastomeric net material. The film layer may be formed of urethane, vinyl or a combination thereof and is cast onto a sheet of release paper. The release paper serves as a mold for the film layer and is generally removed prior to coupling the film layer with the adhesive layer and elastomeric net material. The adhesive layer is positioned between the film layer and elastomeric net material and may be formed of a urethane foam material. The net material may be formed of a polyester elastomer that is woven or biaxially-oriented extruded. In one alternative embodiment, the film layer may also be directly cast to the net material without the use of the adhesive layer.

The present invention further provides for a method of manufacturing the seating composite for a chair. The method includes casting the film layer onto the release paper, removing the release paper from the film layer, positioning the adhesive layer between the film layer and the elastomeric net material, and laminating the film layer to the net material. In the alternative, the method may eliminate the step of positioning the adhesive layer between the film layer and the net material, and directly casting the film layer to the net material.

Additional objects, advantages and novel features of the invention will be set forth in part in the description which follows, and in part will become apparent to those in the practice of the invention.

### BRIEF DESCRIPTION OF THE SEVERAL VIEWS OF THE DRAWINGS

In the accompanying drawings which form a part of this specification and which are to be read in conjunction therewith, and in which like reference numerals are used to indicate like parts and their various views:

FIG. 1 is a perspective view of a chair including a seating composite constructed in accordance with the present invention;

FIG. 2 is an enlarged top plan view of the seating composite with portions broken away to illustrate a film layer, an adhesive layer and an elastomeric net material;

FIG. 3 is a cross-sectional view of the seating composite taken along line 3-3 in FIG. 2;

FIG. 4 is a flow chart illustrating a method of manufacturing the seating composite shown in FIG. 2;

FIG. 5 is a cross-sectional view of an alternative embodiment of the seating composite of the present invention showing a film layer and an elastomeric net material; and

FIG. 6 is a flow chart illustrating a method of manufacturing the alternative seating composite shown in FIG. 5.

### DETAILED DESCRIPTION OF THE INVENTION

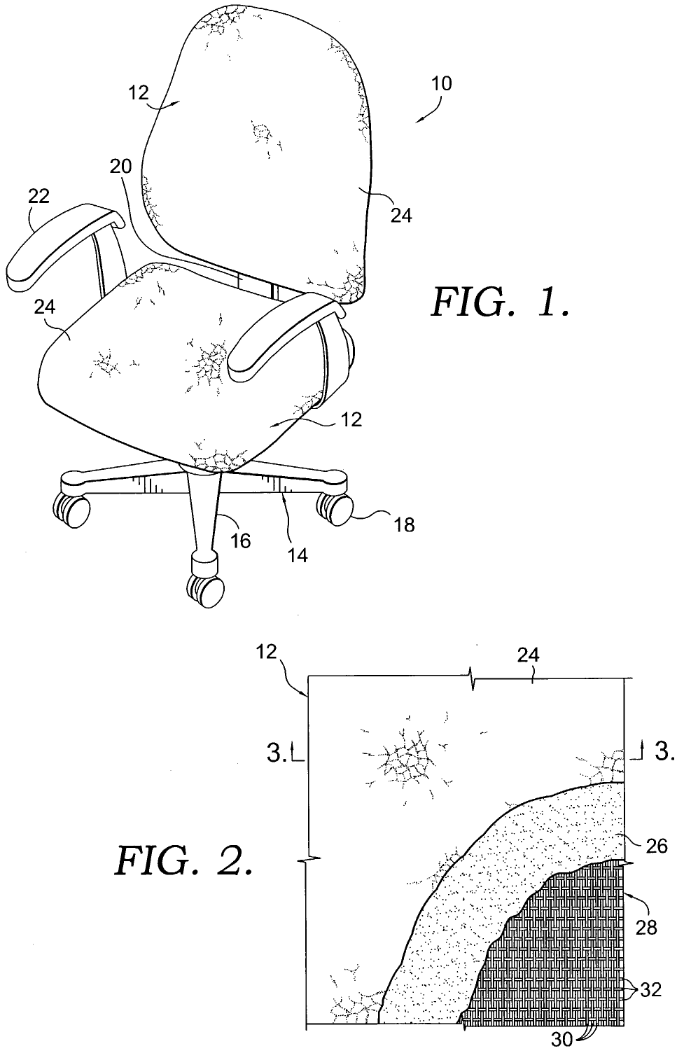

Referring now to the drawings in detail, and initially to FIG. 1, numeral 10 generally designates a chair constructed with a seating composite 12 of the present invention. Chair 10 includes a base 14 having a post, not shown, a plurality of legs 16 and casters 18. Each of legs 16 extend radially from the upstanding post and are used to stabilize chair 10 on a surface. Casters 18 are mounted to the distal ends of legs 16 and facilitate the movement of chair 10 with respect to the surface. A seat frame is supported by the post and typically may be moved upward and downward relative to the post to adjust the height of the seat. In addition, a back frame is coupled with the seat frame using a J-back component 20, which allows the back frame to move between reclined and upright positions. A pair of armrests 22 are positioned on opposite sides of chair 10 and are mounted to the seat frame, although it is understood that armrests 22 may also be mounted to the back frame.

Seating composite 12 may be stretched across the seat frame and/or the back frame and held into position by an elastic band, one or more clips, rivets or other known mechanical fastening devices. The tension in seating composite 12 is sufficient to support a user when sitting in the seat or applying pressure to the back of chair 10. It will be understood and appreciated that chair 10 shown in FIG. 1 is merely provided as an example of the type of chair that seating composite 12 may be used with, and it is within the scope of the present invention to use the seating composite of the present invention with other styles of chairs. For instance, the seating composite may be used as a support component on golf cart seats, restaurant benches, recliner chairs and the like.

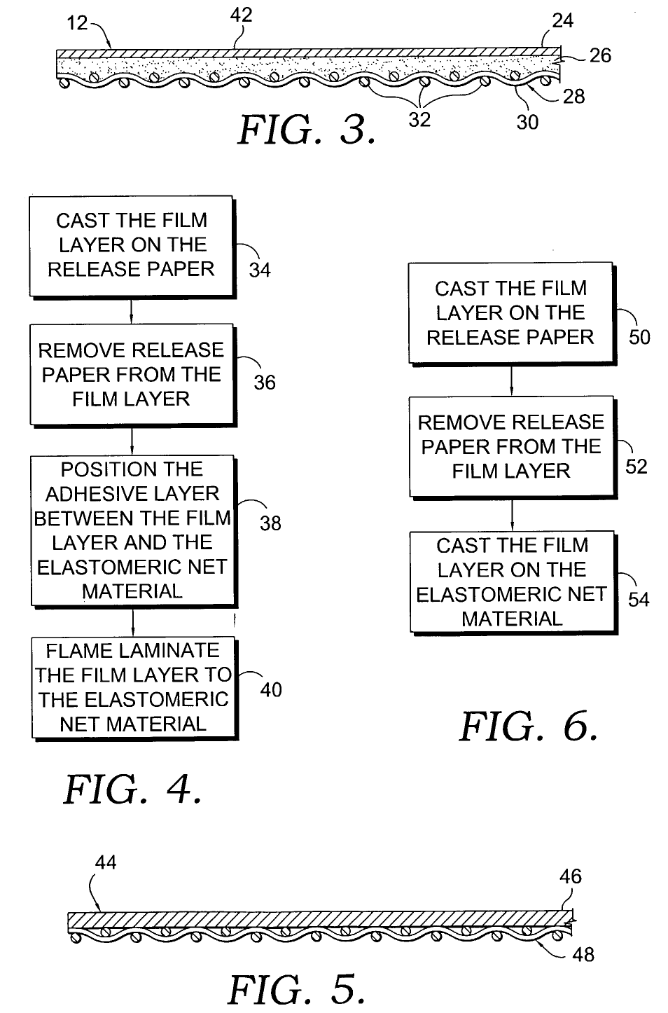

As best seen in FIGS. 2 and 3, seating composite 12 includes a film layer 24, an adhesive layer 26 and a net material 28. Film layer 24 is positioned in such a way to come into contact with a user sitting in chair 10 and may be formed of urethane, vinyl or a urethane/vinyl blend. It is also within the scope of the present invention to form film layer 24 of other materials provided the material has an adequate elasticity to operate in accordance with the principles set forth herein. Film layer 24 is formed by casting the urethane, vinyl, or urethane/vinyl blend onto a sheet of release paper. The release paper is later removed when the film layer is laminated to adhesive layer 26 and net material 28, which will be described in more detail below. While the thickness of film layer 24 may vary, the preferred thickness of film layer 24 is about 0.3 to 1.0 millimeters.

Adhesive layer 26 is positioned between film layer 24 and net material 28 and is used to bond, laminate or otherwise couple film layer 24 with net material 28. Adhesive layer 26 is preferably formed of urethane foam, but it will be understood that adhesive layer 26 may also be formed of other types of material having adequate elasticity and resiliency characteristics. In particular, adhesive material 26 generally has elongation and resiliency characteristics that are adequate to stretch and retract along with film layer 24 and elastomeric net material 28 without cracking, breaking or otherwise losing its elasticity. Further, it is preferred that adhesive layer 26 does not interfere with the mechanical properties of elastomeric net material 28.

As best seen in FIGS. 2 and 3, elastomeric net material 28 is positioned underneath adhesive layer 26, and on the side that is opposite of film layer 24. Net material 28 may be formed of a polyester elastomer, such as HYTREL® or any other suitable elastic material. Elastomeric net material 28 includes a first set of filaments or warp 30 that are crossed with a second set of filaments or weft 32 to form a plain weave pattern. For instance, net material 28 may be plain weave with 20 ends per inch on first set of filaments 30 and 15 picks per inch on second set of filaments 32. Even though first and second sets of filaments 30, 32 are shown in a plain weave pattern, it is also within the scope of the present invention to weave first and second set of filaments 30, 32 in other types of patterns. Furthermore, it will also be understood that other type of net forms may be used, such as, but not limited to, a biaxially-oriented extruded net. The hardness of net material 28 may of course vary, but first and second set of filaments 30, 32 preferably have a hardness of about 40 to 75 durometers, where first and second set of filaments 30, 32 have the same or different hardness values. The diameter of first and second set of filaments 30, 32 is preferably about 0.1 to 0.6 millimeters. For example, the diameter of first set of filaments 30 may be about 0.5 millimeters, and the diameter of second set of filaments 32 may be about 0.3 millimeters. However, it will be understood and appreciated that the filament 30, 32 diameters may be greater than or less than the aforementioned range.

As best seen in FIG. 4, seating composite 12 is manufactured by first casting film layer 24 onto the release paper as seen in step 34. In general, the release paper is used as a mold or substrate for film layer 24 and may be formed of wax paper or other suitable materials. The surface of the release paper that film layer 24 comes into contact with may have a variety of different grains and textures, which will determine the appearance of the surface of the film layer 24. Specifically, once film layer 24 has cured to the release paper, the release paper is removed from film layer 24 in step 36, giving the surface of the film layer 24 a leather-like, plastic-like, smooth or other type of finish. After the release paper is removed from film layer 24, adhesive layer 26 is positioned between film layer 24 and elastomeric net layer 28 in step 38. In step 40, the film layer 24 is flame laminated to elastomeric net material 28. The resulting seating composite 12 may then be stretched across the seat frame and/or back frame so that the tension in the seating composite 12 is sufficient to support a user sitting in chair 10. The greater the tension of net material 28, the less net material 28 will move relative to the seat and back frame when a user sits in chair 10. Seating composite 12 is then secured to the seat frame and/or back frame by an elastic band, one or more clips, rivets, or other types of mechanical fastening devices.

In operation, a user that sits in chair 10 will come into contact with an external surface 42 of film layer 24 as best seen in FIG. 3. The weight of the user causes film layer 24, adhesive layer 26 and elastomeric net material 28 to stretch with respect to the seat and back frame. Specifically, film layer 24 and adhesive layer 26 will stretch along with elastomeric net material 28 without cracking, breaking apart or otherwise significantly losing any of their mechanical properties. Once seating composite 12 and the user reach a static position, seating composite 12 will support a user as long as he or she is sitting in chair 10. As the user gets up from sitting in chair 10, film layer 24, adhesive layer 26 and net material 28 retract or otherwise return to their original positions without compromising the integrity of seating composite 12. The fact that seating composite 12 may be stretched and then returned to its original position without any significant deterioration of its mechanical properties demonstrates the good resiliency and memory properties of seating composite 12.

During a test, the seating composite 12 was stretched about 5% and secured to a 24 inch by 24 inch chair frame. Next, approximately 175 pounds was placed on top of the seating composite about in the middle of the frame where a deflection of about 2 inches was observed. Seating composite 12 was then subjected to the Business and Institutional Furniture Manufactures Association (BIFMA) cycle test. After about 100,000 cycles, a loss equal to less than 6% of the original bearing values was observed, thus demonstrating the good resiliency and memory properties of seating composite 12.

As best seen in FIG. 5, an alternative seating composite 44 is also within the scope of the present invention. As with seating composite 12, seating composite 44 includes a film layer 46 and an elastomeric net material 48. However, in contrast to seating composite 12, seating composite 44 does not include an adhesive layer positioned between film layer 46 and elastomeric net material 48. Instead, as best seen in FIG. 6, seating composite 44 is manufactured by casting film layer 46 onto a sheet of release paper in step 50, removing the release paper from film layer 46 in step 52 and then casting film layer 46 directly onto elastomeric net material 48 in step 54. It will be understood that film layer 46 may need to be thicker than film layer 24 that was used in seating composite 12 to prevent elastomeric net material 48 from telegraphing through film layer 46. Further, the operation of seating composite 44 is substantially similar to seating composite 12 and will not be discussed in any further detail.

It can, therefore, be seen that the invention is one that is designed to overcome the drawbacks and deficiencies existing in the prior art. Specifically, the use of a film layer, adhesive layer, and elastomeric net material in the seating composite of the present invention provides for high resiliency and good memory characteristics. The fact that the present seating composite has good resiliency and memory characteristics allows the seating composite to stretch and retract without any significant loss of its mechanical properties. In addition, the manufacturing costs associated with constructing a chair using the seating composite of the present invention are also reduced since a user may be supported in the chair without the need for installing springs, foam, or other mechanical support devices. The comfort level of the chair is also improved by providing a film layer that comes into contact with a user as opposed to the abrasive mesh-like material used in other types of chairs. Further, the use of a film layer as an external layer for the chair covering allows for a leather-like or plastic-like texture which enhances the appearance of the chair.

While particular embodiments of the invention have been shown, it will be understood, of course, that the invention is not limited thereto, since modifications may be made by those skilled in the art, particularly in light of the foregoing teachings. Reasonable variation and modification are possible within the scope of the foregoing disclosure of the invention without departing from the spirit of the invention.

I claim:

1. A seating composite comprising:
a film layer; and
an elastomeric net material coupled with the film layer.

2. The seating composite in claim 1, further comprising an adhesive layer positioned between the film layer and the elastomeric net material.

3. The seating composite in claim 2, wherein the adhesive layer is formed of urethane foam.

4. The seating composite in claim 1, wherein the film layer is formed of a material selected from the group consisting of urethane, vinyl or any combination thereof.

5. The seating composite in claim 1, wherein the thickness of the film layer is about 0.3 to 1.0 millimeters.

6. The seating composite in claim 1, wherein the net material is elastomeric woven net.

7. The seating composite in claim 1, wherein the net material is elastomeric biaxially-oriented extruded net.

8. The seating composite in claim 1, wherein the elastomeric net material includes a first set of filaments and a second set of filaments, wherein the first set of filaments are crossed by the second set of filaments.

9. The seating composite in claim 8, wherein the first set of filaments have a hardness of about 40 to 75 durometers, and wherein the second set of filaments have a hardness of about 40 to 75 durometers.

10. The seating composite in claim 8, wherein the diameter the filaments in the first set of filaments is about 0.1 to 0.6 millimeters, and wherein the diameter of the filaments in the second set of filaments is about 0.1 to 0.6 millimeters.

11. A method of manufacturing a seating composite for a chair, the method comprising:
providing a film layer and a sheet of release paper;
casting the film layer onto the release paper;
removing the release paper from the film layer;
providing an elastomeric net material; and
coupling the film layer to the elastomeric net material.

12. The method of claim 11, further comprising:
providing an adhesive layer;
positioning the adhesive layer between the film layer and the elastomeric net material; and
laminating the film layer, the adhesive layer and the elastomeric net material together.

13. The method of claim 12, wherein the film layer, the adhesive layer and the elastomeric net material are flame laminated.

14. The method of claim 12, wherein the adhesive layer is formed of urethane foam.

15. The method of claim 11, wherein the film layer is formed of a material selected from the group consisting of urethane, vinyl or a combination thereof.

16. The method of claim 11, wherein the thickness of the film layer is about 0.3 to 1.0 millimeters.

17. The method of claim 11, wherein the net material is elastomeric woven net.

18. The method of claim 11, wherein the net material is elastomeric biaxially-oriented extruded net.

19. The method of claim 11, wherein the elastomeric net material is formed by crossing a first and second set of filaments with a second set of filaments.

20. The method of claim 19, wherein the first set of filaments has a hardness of about 40 to 75 durometers, and wherein the second set of filaments has a hardness of about 40 to 75 durometers.

21. The method of claim 19, wherein the diameter of the first set of filaments are about 0.1 to 0.6 millimeters, and wherein the diameter of the second set of filaments are about 0.1 to 0.6 millimeters.

22. The method of claim 12, wherein the release paper is formed of wax paper.
